(19) United States
(12) Patent Application Publication
(10) Pub. No.: US 2025/0068560 A1
(43) Pub. Date: Feb. 27, 2025

(54) METHOD AND DEVICE FOR CONFIGURING ZONES OF ZNS SSD

(71) Applicant: Samsung Electronics Co., Ltd., Suwon-si (KR)

(72) Inventors: Xing HE, XiAn (CN); Hao YAN, XiAn (CN); Zhao CHEN, XiAn (CN); Yiwen ZHANG, XiAn (CN); Yanlong YANG, XiAn (CN)

(73) Assignee: Samsung Electronics Co., Ltd., Suwon-si (KR)

(21) Appl. No.: 18/603,572

(22) Filed: Mar. 13, 2024

(30) Foreign Application Priority Data
Aug. 22, 2023 (CN) 202311062771.9

(51) Int. Cl. G06F 12/02

(52) U.S. Cl. CPC G06F 12/0246

(57) ABSTRACT

A method and device for configuring zones of a Zoned Namespace (ZNS) Solid State Drive (SSD) are provided. The method includes determining types of sizes of zones into which storage space of the ZNS SSD is to be divided and a number of zones having each type of size, and sending information indicating the types of the sizes of the zones and the number of zones having each type of size to the ZNS SSD such that the storage space of the ZNS SSD is divided into zones having different sizes.

### CROSS-REFERENCE TO RELATED APPLICATIONS

This application is based on and claims priority under 35 U.S.C. § 119 to Chinese Patent Application No. 202311062771.9, filed on Aug. 22, 2023, in the China National Intellectual Property Administration, the disclosure of which is incorporated by reference herein in its entirety.

### BACKGROUND

### 1. Field

The present disclosure relates to a technical field for data storage, and more specifically, to a method and device for configuring zones of a Zoned Namespace (ZNS) Solid State Drive (SSD).

### 2. Related Art

Storage space of a ZNS SSD may be divided into a plurality of zones, and the ZNS SSD exposes their zones to a host so that the host may write data to a specific zone. Sizes of zones of existing ZNS SSDs are fixed. For example, zones of a Samsung ZNS SSD may have fixed smaller sizes while zones of a Western Digital ZNS SSD may have fixed larger sizes.

When a size of a zone of a ZNS SSD is small, the zone spans fewer dies and thus a data transmission bandwidth for the zone is smaller. When the size of the zone of the ZNS SSD is larger, the zone spans more dies and thus the data transmission bandwidth for the zone may be increased. When the size of the zone of the ZNS SSD is larger, the zone may store files with different lifetimes, and thus the files stored in the zone may not be simultaneously invalidated, which causes that the zone cannot be reset to be recycled timely. In this case, a storage space utilization for the ZNS SSD is low.

### SUMMARY

Various example embodiments discussed in the present disclosure provide a method and device for configuring zones of a ZNS SSD which are capable of balancing the data transmission bandwidth and the storage space utilization for the ZNS SSD.

According to an aspect of example embodiments of the present disclosure, there is provided a method for configuring zones of Zoned Namespace (ZNS) Solid State Drive (SSD), the method including determining types of sizes of zones into which storage space of the ZNS SSD is to be divided and a number of zones having each type of size, and sending information indicating the types of the sizes of the zones and the number of zones having each type of size to the ZNS SSD such that the storage space of the ZNS SSD is divided into zones having different sizes.

According to example embodiments of the present disclosure, the host side may configure types of sizes of zones and numbers of respective types of sizes of zones more flexibly according to specific needs to take full advantage of respective advantages of large zones having high bandwidth and small zones having high space utilization.

Alternatively, the determining of sizes of zones into which storage space of the ZNS SSD is to be divided and a number of zones having each size includes determining a first number of zones having a first size and a second number of zones having a second size, and the sending of information indicating the sizes of the zones and the number to the ZNS SSD to cause the storage space of the ZNS SSD to be divided into zones having different sizes includes sending the first size, the first number, the second size, and the second number to the ZNS SSD such that the storage space of the ZNS SSD is divided into the first number of zones having the first size and the second number of zones having the second size.

Alternatively, each zone having the first size spans a third number of NAND dies of the ZNS SSD, and each zone having the second size spans a fourth number of NAND dies of the ZNS SSD, wherein the third number is less than the fourth number and the first size is less than the second size.

Alternatively, the third number is 1.

Alternatively, the method further includes receiving a user input comprising the first size, the first number, and the second size, or the first size, the second size, and the second number, and the determining of the first number of zones having the first size and the second number of zones having the second size comprises determining the first number of zones having the first size and the second number of zones having the second size based on the user input.

Alternatively, the user input corresponds to one of feature identifiers 19h to 77h in NVMe specification.

According to another aspect of example embodiments of the present disclosure, there is provided a method for configuring zones of Zoned Namespace (ZNS) Solid State Drive (SSD), the method includes receiving information indicating types of sizes of zones into which storage space of the ZNS SSD is to be divided and a number of zones having each type of size from a host, and dividing the storage space of the ZNS SSD into zones having different sizes based on the information.

According to another aspect of example embodiments of the present disclosure, there is provided a device for configuring zones of Zoned Namespace (ZNS) Solid State Drive (SSD), the device includes a determining unit configured to determine types of sizes of zones into which storage space of the ZNS SSD is to be divided and a number of zones having each type of size, and a sending unit configured to send information indicating the types of the sizes of the zones and the number of zones having each type of size to the ZNS SSD such that the storage space of the ZNS SSD is divided into zones having different sizes.

Alternatively, the determining unit is configured to determine a first number of zones having a first size and a second number of zones having a second size, and the sending unit is configured to send the first size, the first number, the second size, and the second number to the ZNS SSD such that the storage space of the ZNS SSD is divided into the first number of zones having the first size and the second number of zones having the second size.

Alternatively, each zone having the first size spans a third number of NAND dies of the ZNS SSD, and each zone having the second size spans a fourth number of NAND dies of the ZNS SSD.

Alternatively, the third number is less than the fourth number and the first size is less than the second size.

Alternatively, the third number is 1.

Alternatively, the device further includes a receiving unit configured to receive a user input comprising the first size, the first number, and the second size, or the first size, the second size, and the second number, and the determining unit is configured to determine the first number of zones having the first size and the second number of zones having the second size based on the user input.

Alternatively, the user input corresponds to one of the feature identifiers 19h to 77h in NVMe specification.

According to another aspect of example embodiments of the present disclosure, there is provided a Zoned Namespace (ZNS) Solid State Drive (SSD), the ZNS SSD includes a receiving unit configured to receive information indicating types of sizes of zones into which storage space of the ZNS SSD is to be divided and a number of zones having each type of size from a host, and a dividing unit configured to divide the storage space of the ZNS SSD into zones having different sizes based on the information.

In some example embodiments the ZNS SSD further includes a plurality of NAND dies, wherein each of the zones includes one or more dies of the plurality of NAND dies. The dividing unit may be further configured to divide the plurality of NAND dies into at least one large zone including a first number of NAND dies, and at least one a small zone including a single second number of NAND dies, wherein the second number is less than the first number. In at least one example embodiment, the small zone includes a single NAND die. In various example embodiments, the receiving unit is further configured to receive data from the host, which is stored in at least one of the large zone or the small zone. The host may control which zone is used to store the data.

According to another aspect of example embodiments of the present disclosure, there is provided an electronic device including a memory configured to store one or more instructions, a storage device configured to perform the method for configuring zones of the ZNS SSD performed by the ZNS SSD as described herein, and a host processor configured to execute the one or more instructions to cause the host processor to perform the method for configuring zones of the ZNS SSD performed by a host as described herein.

According to another aspect of example embodiments of the present disclosure, there is provided a host storage system including a host comprising a host memory and a host controller, and a storage device configured to perform the method for configuring zones of the ZNS SSD performed by the ZNS SSD as described herein, wherein the host controller is configured to perform the method for configuring zones of the ZNS SSD performed by a host as described herein.

According to another aspect of example embodiments of the present disclosure, there is provided a data center system including a plurality of application servers, and a plurality of storage servers, wherein each of the plurality of application servers is configured to perform the method for configuring zones of the ZNS SSD performed by a host as described herein, and each of the plurality of storage servers is configured to perform the method for configuring zones of the ZNS SSD performed by the ZNS SSD as described herein.

According to another aspect of example embodiments of the present disclosure, there is provided a computer readable storage medium storing a computer program that when executed by a processor causes the processor to implement the method for configuring zones of the ZNS SSD as described herein.

### BRIEF DESCRIPTION OF DRAWINGS

The above and other purposes and features of the present disclosure will become more apparent through the following descriptions made in conjunction with the figures schematically illustrating example embodiments, in which:

FIGS. 1A and 1B illustrate schematic diagrams of relationship between a data transmission bandwidth for a zone of a ZNS SSD and a size of the zone;

FIGS. 2A and 2B illustrate schematic diagrams of relationship between space utilization for a zone of a ZNS SSD and a size of the zone;

FIG. 3 illustrates a flow diagram of a method for configuring zones of a ZNS SSD according to example embodiments of the present disclosure;

FIG. 4 illustrates a flowchart of a method for configuring zones of a ZNS SSD according to example embodiments of the present disclosure;

FIG. 5 is a schematic diagram illustrating a mapping relationship between zones and logic block addresses (LBAs);

FIG. 6 illustrates a block diagram illustrating a structure of a device for configuring zones of a ZNS SSD according to example embodiments of the present disclosure;

FIG. 7 illustrates a block diagram illustrating a structure of a ZNS SSD according to example embodiments of the present disclosure;

FIG. 8 is a schematic diagram of an electronic device according to an example embodiment of the present disclosure;

FIG. 9 is a block diagram of a host storage system according to an example embodiment of the present disclosure; and

FIG. 10 is a schematic diagram of a data center to which storage devices are applied according to an example embodiment of the present disclosure.

### DETAILED DESCRIPTION

Hereinafter, various example embodiments of the present disclosure are described with reference to the accompanying drawings, in which like reference numerals are used to depict the same or similar elements, features, and structures. However, the present disclosure is not intended to be limited by the various example embodiments described herein to a specific example embodiment and it is intended that the present disclosure covers all modifications, equivalents, and/or alternatives of the present disclosure, provided they come within the scope of the appended claims and their equivalents. The terms and words used in the following description and claims are not limited to their dictionary meanings, but are merely used to enable a clear and consistent understanding of the present disclosure. Accordingly, it should be apparent to those skilled in the art that the following description of various example embodiments of the present disclosure is provided for illustration purpose only and not for the purpose of limiting the present disclosure as defined by the appended claims and their equivalents.

It is to be understood that the singular forms include plural forms, unless the context clearly dictates otherwise. The terms “include,” “include,” and “have”, used herein, indicate disclosed functions, operations, or the existence of elements, but does not exclude other functions, operations, or elements.

For example, the expressions “A or B,” or “at least one of A and/or B” may indicate A and B, A, or B. For instance, the expression “A or B” or “at least one of A and/or B” may indicate (1) A, (2) B, or (3) both A and B.

In various example embodiments of the present disclosure, it is intended that when a component (for example, a first component) is referred to as being “coupled” or “connected” with/to another component (for example, a second component), the component may be directly connected to the other component or may be connected through another component (for example, a third component). In contrast, when a component (for example, a first component) is referred to as being “directly coupled” or “directly connected” with/to another component (for example, a second component), another component (for example, a third component) does not exist between the component and the other component.

The expression “configured to”, used in describing various example embodiments of the present disclosure, may be used interchangeably with expressions such as “suitable for,” “having the capacity to,” “designed to,” “adapted to,” “made to,” and “capable of”, for example, according to the situation. The term “configured to” may not necessarily indicate “specifically designed to” in terms of hardware. Instead, the expression “a device configured to” in some situations may indicate that the device and another device or part are “capable of.” For example, the expression “a processor configured to perform A, B, and C” may indicate a dedicated processor (for example, an embedded processor) for performing a corresponding operation or a general purpose processor (for example, a central processing unit (CPU) or an application processor (AP)) for performing corresponding operations by executing at least one software program stored in a memory device.

The terms used herein are to describe certain example embodiments of the present disclosure, but are not intended to limit the scope of other example embodiments. Unless otherwise indicated herein, all terms used herein, including technical or scientific terms, may have the same meanings that are generally understood by a person skilled in the art. In general, terms defined in a dictionary should be considered to have the same meanings as the contextual meanings in the related art, and, unless clearly defined herein, should not be understood differently or as having an excessively formal meaning. In any case, even terms defined in the present disclosure are not intended to be interpreted as excluding example embodiments of the present disclosure.

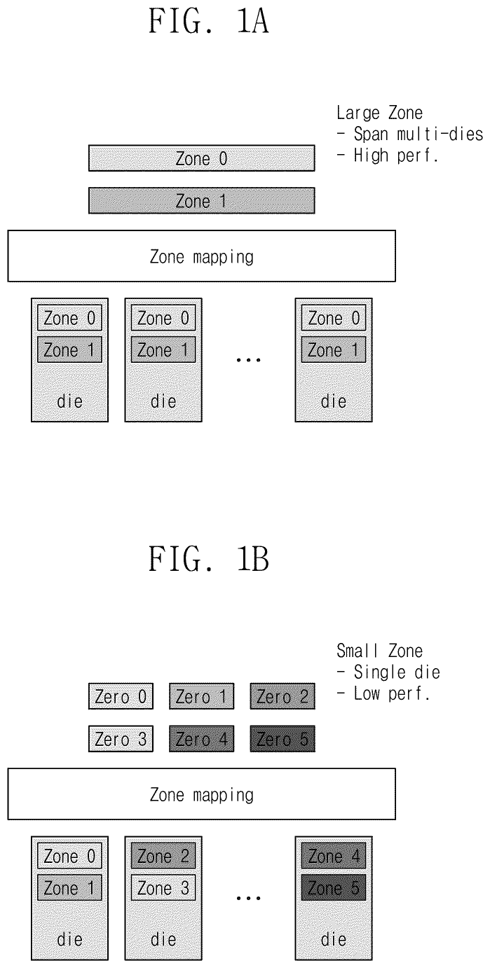

FIGS. 1A and 1B illustrate schematic diagrams of relationship between a data transmission bandwidth and a size of a zone of a ZNS SSD for the zone.

Referring to FIG. 1A, when a size of a zone of a ZNS SSD is large, it may span multiple dies, and in this case, a high data transmission bandwidth can be ensured. Referring to FIG. 1B, when the size of the zone is small, it only spans a single die, and in this case, the data transmission bandwidth for the zone is small, thereby reducing data transmission performance.

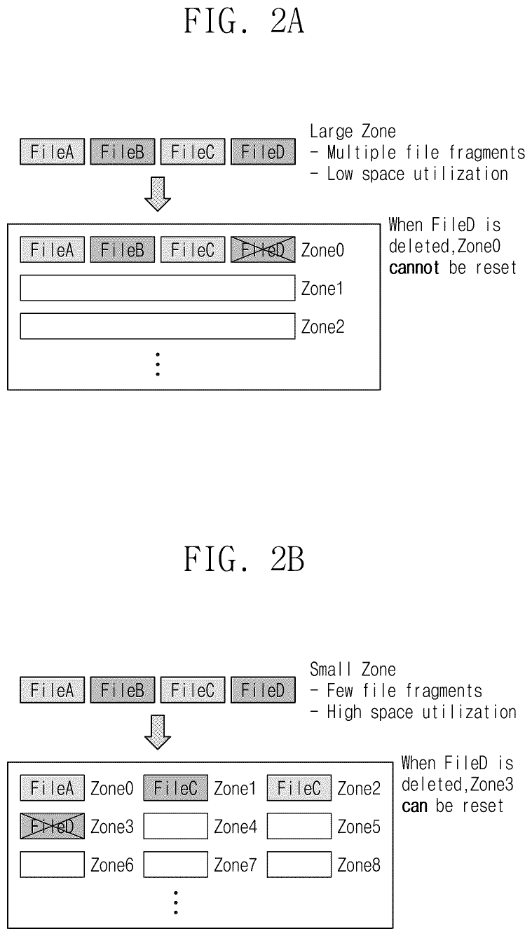

FIGS. 2A and 2B illustrate schematic diagrams of relationship between space utilization for zones of a ZNS SSD and sizes of the zones.

Referring to FIG. 2A, when a size of a zone of a ZNS SSD is large, the zone may store files with different lifetimes and in this case the stored files cannot be deleted simultaneously which causes that the zone cannot be recycled timely. For example, a file D in a zone 0 is deleted due to expiration of its lifetime. However, lifetimes of a file A, a file B and a file C have not expired, and in this case, since storage space is still occupied by the file D, the zone 0 cannot be recycled even though the file D is a useless file. Referring to FIG. 2B, when the size of the zone is small, files stored in the zone may have identical lifetimes and thus the files in the zone can be deleted at the same time, thereby improving space utilization for the zone. For example, the file D in a zone 3 is deleted due to expiration of its lifetime, and thus the zone 3 may be reset, thereby ensuring that the zone 3 can be recycled timely.

As described above, the size of the zone being large may result in more file fragments, which leads to reduction of storage space utilization. When the size of the zone is small, the zone spans fewer dies, thereby resulting in lower data transmission bandwidth. Existing ZNS SSDs are unable to effectively keep balance between the data transmission bandwidth and the space utilization.

The method and device for configuring zones of a ZNS SSD of the present disclosure are capable of at least addressing the above issues.

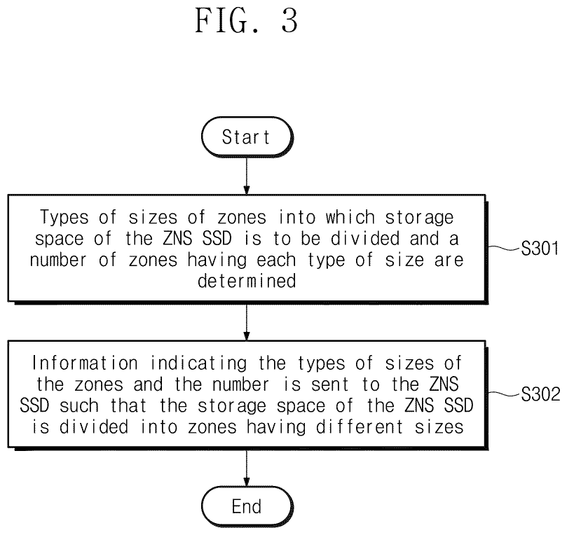

FIG. 3 illustrates a flowchart of a method for configuring zones of a ZNS SSD according to an example embodiment of the present disclosure.

Referring to FIG. 3, at step S301, types of sizes of zones into which storage space of the ZNS SSD is to be divided and a number of zones having each type of size are determined.

At step S302, information indicating the types of sizes of the zones and the number is sent to the ZNS SSD such that the storage space of the ZNS SSD is divided into zones having different sizes. That is, the information is used by the ZNS SSD to divide its storage space into zones having different types of sizes.

It should be understood by those skilled in the art that the dividing herein refers to physical dividing instead of logical dividing. For example, for any zone with a particular size, the zone can be recycled only when all data on the zone is invalid, and the zone cannot be partially recycled when a part of data on the zone is valid. It should be understood by those skilled in the art that the types of the sizes of the zones into which the storage space of the ZNS SSD is to be divided may be two or more types. For ease of description, the types of sizes of the zones into which the storage space of the ZNS SSD is to be divided are illustrated below as being two types.

As an example, the step S301 may include determining a first number of zones having a first size and a second number of zones having a second size and the step S302 may include sending the first size, the first number, the second size, and the second number to the ZNS SSD such that the storage space of the ZNS SSD is divided into the first number of zones having the first size and the second number of zones having the second size.

As an example, each zone having the first size spans a third number of NAND dies of the ZNS SSD, and each zone having the second size spans a fourth number of NAND dies of the ZNS SSD, wherein the third number is less than the fourth number and the first size is less than the second size.

As an example, the third number is 1.

As an example, the method may further include receiving a user input comprising the first size, the first number, and the second size, or the first size, the second size, and the second number. The determining of the first number of zones having the first size and the second number of zones having the second size may include determining the first number of zones having the first size and the second number of zones having the second size based on the user input.

Specifically, when the user input includes the first size, the first number, and the second size, the calculated second number may not be an integer, and in this case the second number is rounded up so that there is reserved space in addition to zones with the first size and zones with the second size after the space of the ZNS SSD is divided. For example, if the second number is calculated to be 100.5 based on the storage space of the ZNS SSD, the first size, the first number and the second size, the second number may be determined to be 100 so that there will be 0.5 m reserved space in the ZNS SSD, wherein the m indicates the second size.

Similarly, when the user input includes the first size, the second size, and the second number, the calculated first number may not be an integer, and in this case the number is rounded up so that there is reserved space in addition to the zones with the first size and the zones with the second size after the space of the ZNS SSD is divided.

As an example, a command may be added to the NVMe specification for setting information for dividing storage space of the ZNS SSD, for example, a size (e.g., the first size) of small zones, the number (e.g., the first number) of the small zones and a size (e.g., the second size) of large zones, or the size (e.g., the first size) of the small zones, the size (e.g., the second size) of large zones, and the number (e.g., the second number) of the large zones.

As an example, the user input may correspond to one of feature identifiers 19h to 77h in the NVMe specification.

Since the feature identifiers 19h to 77h are reserved feature identifiers, such extension would add little cost and complexity, thereby preserving streamlined nature of the ZNS SSD.

As an example, the feature identifier 19h in the NVMe specification may be set as a feature identifier for setting the information for dividing the storage space of the ZNS SSD, and table 1 illustrates attribute information for the feature identifier 19h.

TABLE 1
Zone Info-command Dword 11

| Bits | Description |
|---|---|
| 31:12 | small Zone number: this filed specifies the number |
| | of the small Zones in the ZNS SSD. 0~1048576 |
| 11:08 | large Zone number: this filed specifies the number of |
| | the large Zones in the ZNS SSD. 0~16 GB |
| 07:00 | small Zone size(MB): this filed specifies the size of |
| | the small Zones in the ZNS SSD(alignment with |
| | block size). 0~256 MB |

Referring to Table 1, the number of the small zones may be indicated by bits 31-12 of the identifier 19h, the size of large zones may be indicated by bits 11-08 of the identifier 19h, and the size of small zones may be indicated by bits 07-00 of the identifier 19h.

For example, when the identifier 19h is used as the identifier for setting the zone division information for the ZNS SSD, the identifier 19h may be set (i.e., setting the information for the zones used to configure the ZNS SSD) by entering values corresponding to the three fields described above via for example the host.

For example, the attributes for the identifier 19h may be set based on a command: nvme set-feature/dev/nvme0-fOx19/dev/nvme0n1-v 0xXX. For example, if the small zone size is 32 MB (0×20), the large zone size is 2 GB (0×02) and the number of small zones is 10240 (0×2800), then -v=0×2800220.

Based on this command information and a size of the storage space of the ZNS SSD, the host may determine the number of the large zones. It should be understood by those skilled in the art that the number of the large zones may also be set based on the feature identifier 19h instead of setting the number of the small zones, such that the host may determine the number of the small zones based on the attribute information of feature identifier 19h and the size of the storage space of the ZNS SSD.

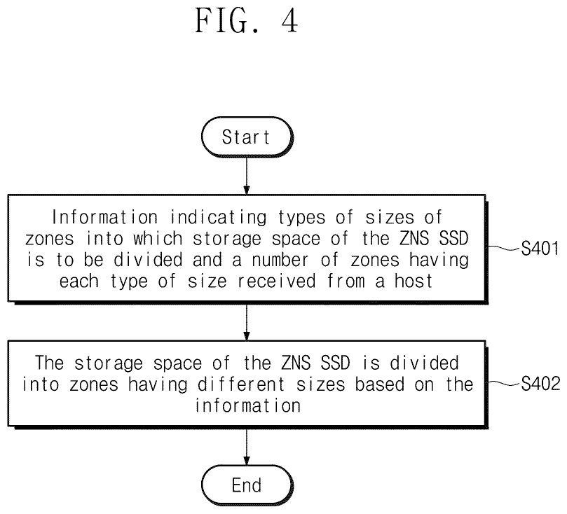

FIG. 4 illustrates a flowchart of a method for configuring zones of a ZNS SSD according to example embodiments of the present disclosure.

Referring to FIG. 4, at step S401, information indicating types of sizes of zones into which storage space of the ZNS SSD is to be divided and a number of zones having each type of size received from a host.

At step S402, the storage space of the ZNS SSD is divided into zones having different sizes based on the information.

It has been described above how the host determines the types of sizes of the zones into which storage space of the ZNS SSD is to be divided and the number of zones having each type of size, so that the ZNS SSD may divide the storage space of the ZNS SSD based on the information indicating the types of sizes of the zones into which storage space of the ZNS SSD is to be divided and the number of the zones having each type of size.

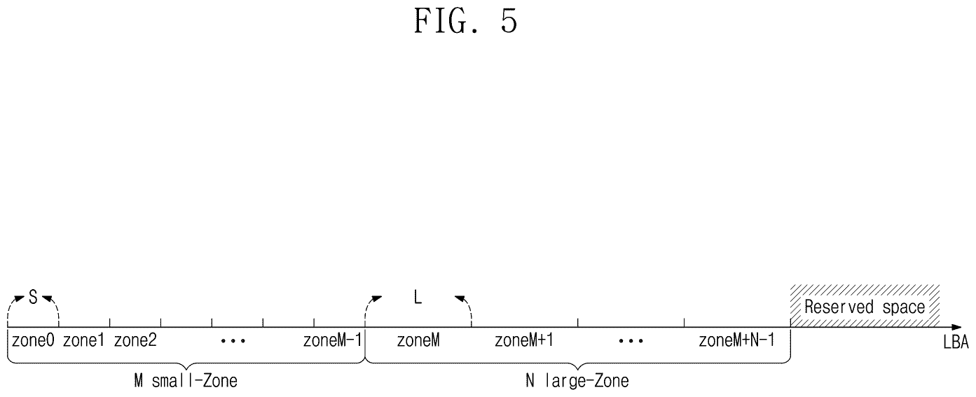

FIG. 5 illustrates the mapping relationship between the zones and the LBAs. Referring to FIG. 5, based on configuration information received from the host, the ZNS SSD may map M small zones and N large zones to LBAs via a zone Flash Translation Layer (FTL) to divide the storage space of the ZNS SSD into M small zones and N large zones. In addition, since the calculated number of the large zones may not be an integer, the ZNS SSD may also have reserved space.

According to the example embodiments of the present disclosure, the host side may configure types of sizes of zones and numbers of respective types of sizes of zones more flexibly according to specific needs to take full advantage of respective advantages of large zones having high bandwidth and small zones having high space utilization.

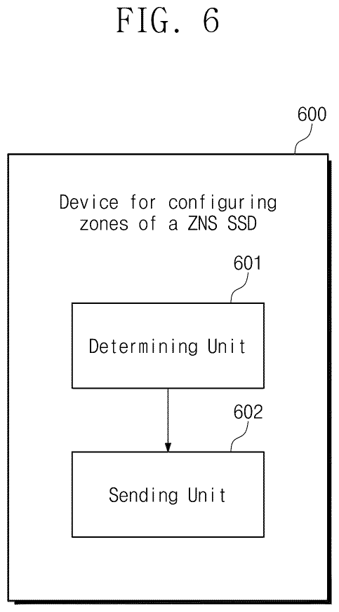

The method for configuring zones of a ZNS SSD according to example embodiments of the present disclosure has been described above with reference to FIGS. 1 to 5, and the device for configuring zones of a ZNS SSD, a ZNS SSD, an electronic device, a storage system, and a data center according to example embodiments of the present disclosure are described below with reference to FIGS. 6 to 10.

FIG. 6 illustrates a block diagram of a structure of a device for configuring zones of a ZNS SSD 600 according to example embodiments of the present disclosure.

Referring to FIG. 6, the device for configuring the zones of the ZNS SSD 600 may include a determining unit 601 and a sending unit 602. It should be understood by those skilled in the art that the device for configuring the zones of the ZNS SSD 600 may additionally include other components, and that at least one of components included in the device for configuring the zones of the ZNS SSD 600 may be combined or divided.

As an example, the determining unit 601 may be configured to determine types of sizes of zones into which storage space of the ZNS SSD is to be divided and a number of zones having each type of size.

As an example, the sending unit 602 may be configured to send information indicating the types of the sizes of the zones and the number to the ZNS SSD such that the storage space of the ZNS SSD is divided into zones having different sizes.

As an example, the determining unit 601 may be configured to determine a first number of zones having a first size and a second number of zones having a second size.

As an example, the sending unit 602 may be configured to send the first size, the first number, the second size, and the second number to the ZNS SSD such that the storage space of the ZNS SSD is divided into the first number of zones having the first size and the second number of zones having the second size.

As an example, each zone having the first size spans a third number of NAND dies of the ZNS SSD, and each zone having the second size spans a fourth number of NAND dies of the ZNS SSD, wherein the third number is less than the fourth number and the first size is less than the second size.

As an example, the third number is 1.

As an example, the device for configuring the zones of the ZNS SSD 600 may further include a receiving unit (not shown) configured to receive a user input including the first size, the first number, and the second size; or the first size, the second size, and the second number.

As an example, the determining unit 601 may be configured to determine the first number of zones having the first size and the second number of zones having the second size based on the user input.

As an example, the user input corresponds to one of the feature identifiers 19h to 77h in the NVMe specification.

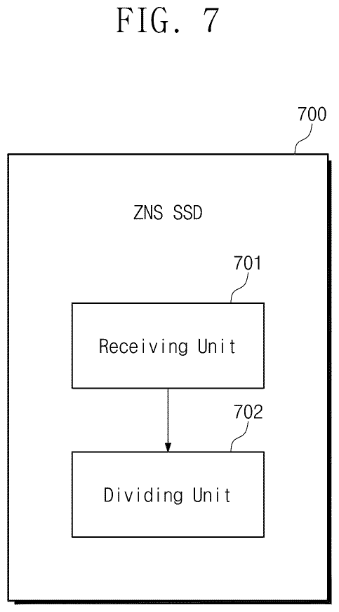

FIG. 7 illustrates a block diagram of a structure of a ZNS SSD 700 according to an example embodiment of the present disclosure.

Referring to FIG. 7, the ZNS SSD 700 may include a receiving unit 701 and a dividing unit 702. It should be understood by those skilled in the art that the ZNS SSD 700 may additionally include other components and that at least one of components included in the ZNS SSD 700 may be combined or divided.

As an example, the receiving unit 701 is configured to receive information indicating types of sizes of zones into which storage space of the ZNS SSD is to be divided and a number of zones having each type of size from a host.

As an example, the dividing unit 702 is configured to divide the storage space of the ZNS SSD into zones having different sizes based on the information.

According to example embodiments of the present disclosure, there is provided a computer readable storage medium storing a computer program that when executed by a processor causes the processor to implement the method for configuring zones of a ZNS SSD as described herein.

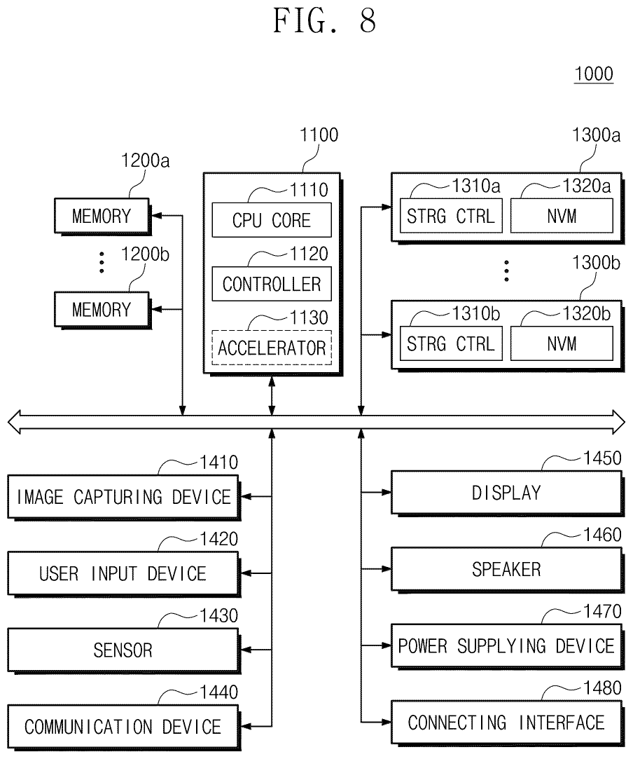

FIG. 8 is a schematic diagram of an electronic device 1000 according to an example embodiment of the present disclosure.

The electronic device 1000 of FIG. 8 may basically be a mobile system, such as a portable communication terminal (e.g., a mobile phone), a smartphone, a tablet personal computer (PC), a wearable device, a healthcare device, or an Internet of things (IOT) device. However, the electronic device 1000 of FIG. 8 is not necessarily limited to the mobile system and may be a PC, a laptop computer, a server, a media player, or an automotive device (e.g., a navigation device).

Referring to FIG. 8, the electronic device 1000 may include a main processor 1100, memories (e.g., 1200a and 1200b), and storage devices (e.g., 1300a and 1300b). In addition, the electronic device 1000 may include at least one of an image capturing device 1410, a user input device 1420, a sensor 1430, a communication device 1440, a display 1450, a speaker 1460, a power supplying device 1470, and a connecting interface 1480.

The main processor 1100 may control all operations of the electronic device 1000, more specifically, operations of other components included in the electronic device 1000. The main processor 1100 may be implemented as a general-purpose processor, a dedicated processor, or an application processor.

The main processor 1100 may include at least one CPU core 1110 and further include a controller 1120 configured to control the memories 1200a and 1200b and/or the storage devices 1300a and 1300b. In some example embodiments, the main processor 1100 may further include an accelerator 1130, which is a dedicated circuit for a high-speed data operation, such as an artificial intelligence (AI) data operation. The accelerator 1130 may include a graphics processing unit (GPU), a neural processing unit (NPU) and/or a data processing unit (DPU) and be implemented as a chip that is physically separate from the other components of the main processor 1100.

The memories 1200a and 1200b may be used as main memory devices of the electronic device 1000. Although each of the memories 1200a and 1200b may include a volatile memory, such as static random access memory (SRAM) and/or dynamic RAM (DRAM), each of the memories 1200a and 1200b may include non-volatile memory, such as a flash memory, stage-change RAM (PRAM) and/or resistive RAM (RRAM). The memories 1200a and 1200b may be implemented in the same package as the main processor 1100.

The storage devices 1300a and 1300b may serve as non-volatile storage devices configured to store data regardless of whether power is supplied thereto, and have larger storage capacity than the memories 1200a and 1200b. The storage devices 1300a and 1300b may respectively include storage controllers (STRG CTRL) 1310a and 1310b and NVMs (Non-Volatile Memory) 1320a and 1320b configured to store data via the control of the storage controllers 1310a and 1310b. Although the NVMs 1320a and 1320b may include flash memories having a two-dimensional (2D) structure or a three-dimensional (3D) V-NAND structure, the NVMs 1320a and 1320b may include other types of NVMs, such as PRAM and/or RRAM.

The storage devices 1300a and 1300b may be physically separated from the main processor 1100 and included in the electronic device 1000 or implemented in the same package as the main processor 1100. In addition, the storage devices 1300a and 1300b may have types of solid-state devices (SSDs) or memory cards and be removably combined with other components of the system 100 through an interface, such as the connecting interface 1480 that will be described below. The storage devices 1300a and 1300b may be devices to which a standard protocol, such as a universal flash storage (UFS), an embedded multi-media card (eMMC), or a non-volatile memory express (NVMe), is applied, without being limited thereto.

The image capturing device 1410 may capture still images or moving images. The image capturing device 1410 may include a camera, a camcorder, and/or a webcam.

The user input device 1420 may receive various types of data input by a user of the electronic device 1000 and include a touch pad, a keypad, a keyboard, a mouse, and/or a microphone.

The sensor 1430 may detect various types of physical quantities, which may be obtained from the outside of the electronic device 1000, and convert the detected physical quantities into electric signals. The sensor 1430 may include a temperature sensor, a pressure sensor, an illuminance sensor, a position sensor, an acceleration sensor, a biosensor, and/or a gyroscope sensor.

The communication device 1440 may transmit and receive signals between other devices outside the electronic device 1000 according to various communication protocols. The communication device 1440 may include an antenna, a transceiver, and/or a modem.

The display 1450 and the speaker 1460 may serve as output devices configured to respectively output visual information and auditory information to the user of the electronic device 1000.

The power supplying device 1470 may appropriately convert power supplied from a battery (not shown) embedded in the electronic device 1000 and/or an external power source, and supply the converted power to each of components of the electronic device 1000.

The connecting interface 1480 may provide connection between the electronic device 1000 and an external device, which is connected to the electronic device 1000 and capable of transmitting and receiving data to and from the electronic device 1000. The connecting interface 1480 may be implemented by using various interface schemes, such as advanced technology attachment (ATA), serial ATA (SATA), external SATA (e-SATA), small computer small interface (SCSI), serial attached SCSI (SAS), peripheral component interconnection (PCI), PCI express (PCIe), NVMe, IEEE 1394, a universal serial bus (USB) interface, a secure digital (SD) card interface, a multi-media card (MMC) interface, an eMMC interface, a UFS interface, an embedded UFS (eUFS) interface, and a compact flash (CF) card interface.

According to an example embodiment of the present disclosure, there is provided an electronic device, and the device includes a memory (for example, memories 1200a and 1200b of FIG. 8) storing one or more instructions, storage devices (for example, storage devices 1300a and 1300b of FIG. 8) configured to the method for configuring zones of the ZNS SSD performed by the ZNS SSD as described herein, and a main processor (for example, main processor 1100 of FIG. 8) configured to execute the one or more instructions to cause the host processor to perform the method for configuring zones of the ZNS SSD performed by for example the host as described herein.

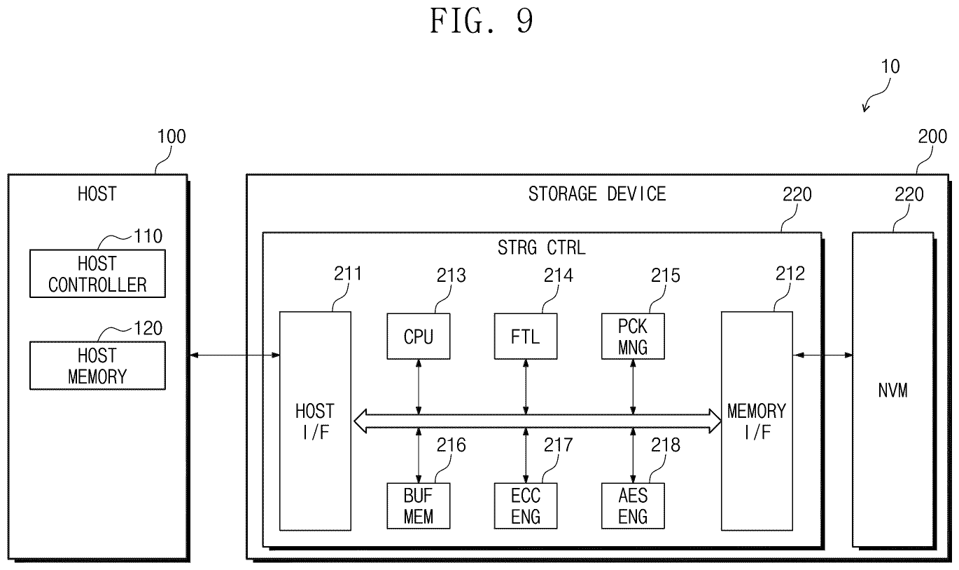

FIG. 9 is a block diagram of a host storage system 10 according to an example embodiment of the present disclosure.

The host storage system 10 may include a host 100 and a storage device 200. Further, the storage device 200 may include a storage controller 210 and an NVM 220. According to an example embodiment, the host 100 may include a host controller 110 and a host memory 120. The host memory 120 may serve as a buffer memory configured to temporarily store data to be transmitted to the storage device 200 or data received from the storage device 200.

The storage device 200 may include storage media configured to store data in response to requests from the host 100. As an example, the storage device 200 may include at least one of an SSD, an embedded memory, and a removable external memory. When the storage device 200 is an SSD, the storage device 200 may be a device that conforms to an NVMe standard. When the storage device 200 is an embedded memory or an external memory, the storage device 200 may be a device that conforms to a UFS standard or an eMMC standard. Each of the host 100 and the storage device 200 may generate a packet according to an adopted standard protocol and transmit the packet.

When the NVM 220 of the storage device 200 includes a flash memory, the flash memory may include a 2D NAND memory array or a 3D (or vertical) NAND (VNAND) memory array. As another example, the storage device 200 may include various other kinds of NVMs. For example, the storage device 200 may include magnetic RAM (MRAM), spin-transfer torque MRAM, conductive bridging RAM (CBRAM), ferroelectric RAM (FRAM), PRAM, RRAM, and various other kinds of memories.

According to an example embodiment, the host controller 110 and the host memory 120 may be implemented as separate semiconductor chips. Alternatively, in some example embodiments, the host controller 110 and the host memory 120 may be integrated in the same semiconductor chip. As an example, the host controller 110 may be any one of a plurality of modules included in an application processor (AP). The AP may be implemented as a System on Chip (SoC). Further, the host memory 120 may be an embedded memory included in the AP or an NVM or memory module located outside the AP.

The host controller 110 may manage an operation of storing data (e.g., write data) of a buffer region of the host memory 120 in the NVM 220 or an operation of storing data (e.g., read data) of the NVM 220 in the buffer region.

The storage controller 210 may include a host interface 211, a memory interface 212, and a CPU 213. Further, the storage controllers 210 may further include a flash translation layer (FTL) 214, a packet manager 215, a buffer memory 216, an error correction code (ECC) engine 217, and an advanced encryption standard (AES) engine 218. The storage controllers 210 may further include a working memory (not shown) in which the FTL 214 is loaded. The CPU 213 may execute the FTL 214 to control data write and read operations on the NVM 220.

The host interface 211 may transmit and receive packets to and from the host 100. A packet transmitted from the host 100 to the host interface 211 may include a command or data to be written to the NVM 220. A packet transmitted from the host interface 211 to the host 100 may include a response to the command or data read from the NVM 220. The memory interface 212 may transmit data to be written to the NVM 220 to the NVM 220 or receive data read from the NVM 220. The memory interface 212 may be configured to comply with a standard protocol, such as Toggle or open NAND flash interface (ONFI).

The FTL 214 may perform various functions, such as an address mapping operation, a wear-leveling operation, and a garbage collection operation. The address mapping operation may be an operation of converting a logical address received from the host 100 into a physical address used to actually store data in the NVM 220. The wear-leveling operation may be a technique for preventing excessive deterioration of a specific block by allowing blocks of the NVM 220 to be uniformly used. As an example, the wear-leveling operation may be implemented using a firmware technique that balances erase counts of physical blocks. The garbage collection operation may be a technique for ensuring usable capacity in the NVM 220 by erasing an existing block after copying valid data of the existing block to a new block.

The packet manager 215 may generate a packet according to a protocol of an interface, which consents to the host 100, or parse various types of information from the packet received from the host 100. In addition, the buffer memory 216 may temporarily store data to be written to the NVM 220 or data to be read from the NVM 220. Although the buffer memory 216 may be a component included in the storage controllers 210, the buffer memory 216 may be outside the storage controllers 210.

The ECC engine 217 may perform error detection and correction operations on read data read from the NVM 220. More specifically, the ECC engine 217 may generate parity bits for write data to be written to the NVM 220, and the generated parity bits may be stored in the NVM 220 together with write data. During the reading of data from the NVM 220, the ECC engine 217 may correct an error in the read data by using the parity bits read from the NVM 220 along with the read data, and output error-corrected read data.

The AES engine 218 may perform at least one of an encryption operation and a decryption operation on data input to the storage controllers 210 by using a symmetric-key algorithm.

According to an example embodiment of the present disclosure, a host storage system is provided, and the system includes a host (for example, host 100 of FIG. 9) including a host memory (for example, host memory 110 of FIG. 9) and a host controller (for example, host controller 120 of FIG. 9), and a storage device (for example, storage device 200 of FIG. 9) configured to perform the method for configuring zones of the ZNS SSD performed by the ZNS SSD as described herein, wherein the host controller is configured to perform the method for configuring zones of the ZNS SSD performed by for example the host as described herein.

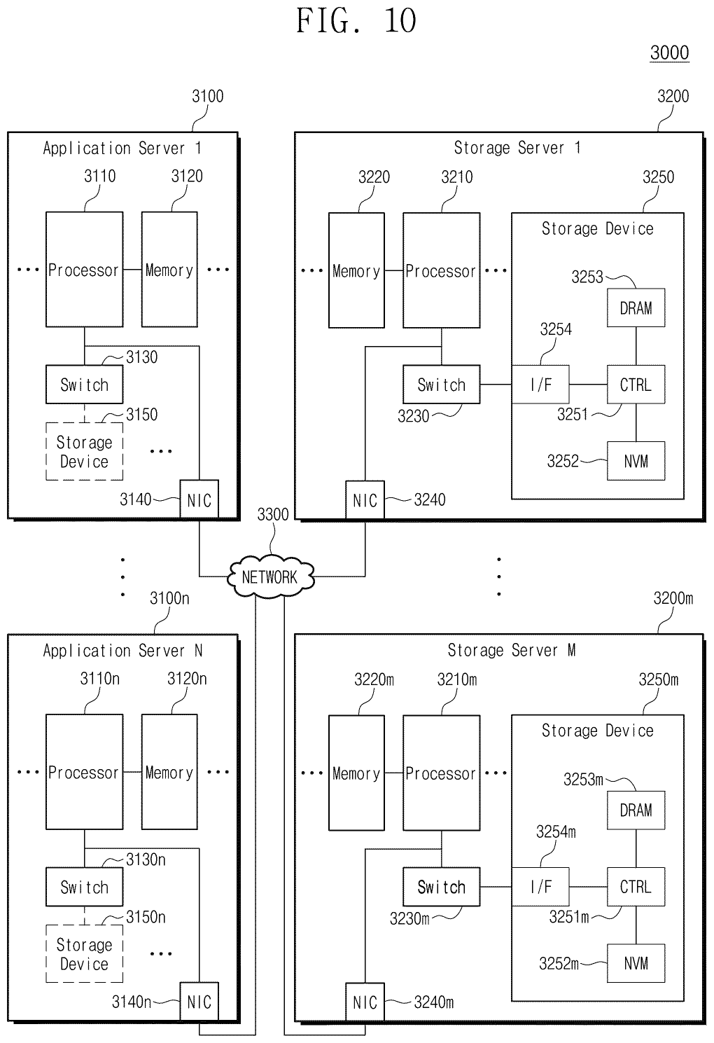

FIG. 10 is a diagram of a data center 3000 to which a storage device is applied according to an example embodiment of the present disclosure.

Referring to FIG. 10, the data center 3000 may be a facility that collects various types of pieces of data and provides services and be referred to as a data storage center. The data center 3000 may be a system for operating a search engine and a database, and may be a computing system used by companies, such as banks, or government agencies. The data center 3000 may include application servers 3100 to 3100n and storage servers 3200 to 3200m. The number of application servers 3100 to 3100n and the number of storage servers 3200 to 3200m may be variously selected according to example embodiments. The number of application servers 3100 to 3100n may be different from the number of storage servers 3200 to 3200m.

The application server 3100 or the storage server 3200 may include at least one of processors 3110 and 3210 and memories 3120 and 3220. The storage server 3200 will now be described as an example. The processor 3210 may control all operations of the storage server 3200, access the memory 3220, and execute instructions and/or data loaded in the memory 3220. The memory 3220 may be a double-data-rate synchronous DRAM (DDR SDRAM), a high-bandwidth memory (HBM), a hybrid memory cube (HMC), a dual in-line memory module (DIMM), Optane DIMM, and/or a non-volatile DIMM (NVMDIMM). In some example embodiments, the numbers of processors 3210 and memories 3220 included in the storage server 3200 may be variously selected. In an example embodiment, the processor 3210 and the memory 3220 may provide a processor-memory pair. In an example embodiment, the number of processors 3210 may be different from the number of memories 3220. The processor 3210 may include a single-core processor or a multi-core processor. The above description of the storage server 3200 may be similarly applied to the application server 3100. In some example embodiments, the application server 3100 may not include a storage device 3150. The storage server 3200 may include at least one storage device 3250. The number of storage devices 3250 included in the storage server 3200 may be variously selected according to example embodiments.

The application servers 3100 to 3100n may communicate with the storage servers 3200 to 3200m through a network 3300. The network 3300 may be implemented by using a fiber channel (FC) or Ethernet. In this case, the FC may be a medium used for relatively high-speed data transmission and use an optical switch with high performance and high availability. The storage servers 3200 to 3200m may be provided as file storages, block storages, or object storages according to an access method of the network 3300.

In an example embodiment, the network 3300 may be a storage-dedicated network, such as a storage area network (SAN). For example, the SAN may be an FC-SAN, which uses an FC network and is implemented according to an FC protocol (FCP). As another example, the SAN may be an Internet protocol (IP)-SAN, which uses a transmission control protocol (TCP)/IP network and is implemented according to a SCSI over TCP/IP or Internet SCSI (iSCSI) protocol. In another example embodiment, the network 3300 may be a general network, such as a TCP/IP network. For example, the network 3300 may be implemented according to a protocol, such as FC over Ethernet (FCoE), network attached storage (NAS), and NVMe over Fabrics (NVMe-oF).

Hereinafter, the application server 3100 and the storage server 3200 will mainly be described. A description of the application server 3100 may be applied to another application server 3100n, and a description of the storage server 3200 may be applied to another storage server 3200m.

The application server 3100 may store data, which is requested by a user or a client to be stored, in one of the storage servers 3200 to 3200m through the network 3300. Also, the application server 3100 may obtain data, which is requested by the user or the client to be read, from one of the storage servers 3200 to 3200m through the network 3300. For example, the application server 3100 may be implemented as a web server or a database management system (DBMS).

The application server 3100 may access a memory 3120n or a storage device 3150n, which is included in another application server 3100n, through the network 3300. Alternatively, the application server 3100 may access memories 3220 to 3220m or storage devices 3250 to 3250m, which are included in the storage servers 3200 to 3200m, through the network 3300. Thus, the application server 3100 may perform various operations on data stored in application servers 3100 to 3100n and/or the storage servers 3200 to 3200m. For example, the application server 3100 may execute an instruction for moving or copying data between the application servers 3100 to 3100n and/or the storage servers 3200 to 3200m. In this case, the data may be moved from the storage devices 3250 to 3250m of the storage servers 3200 to 3200m to the memories 3120 to 3120n of the application servers 3100 to 3100n directly or through the memories 3220 to 3220m of the storage servers 3200 to 3200m. The data moved through the network 3300 may be data encrypted for security or privacy.

The storage server 3200 will now be described as an example. An interface 3254 may provide physical connection between a processor 3210 and a controller 3251 and a physical connection between a network interface card (NIC) 3240 and the controller 3251. For example, the interface 3254 may be implemented using a direct attached storage (DAS) scheme in which the storage device 3250 is directly connected with a dedicated cable. For example, the interface 3254 may be implemented by using various interface schemes, such as ATA, SATA, e-SATA, an SCSI, SAS, PCI, PCIe, NVMe, IEEE 1394, a USB interface, an SD card interface, an MMC interface, an eMMC interface, a UFS interface, an eUFS interface, and/or a CF card interface.

The storage server 3200 may further include a switch 3230 and the NIC (Network Interconnect) 3240. The switch 3230 may selectively connect the processor 3210 to the storage device 3250 or selectively connect the NIC 3240 to the storage device 3250 via the control of the processor 3210.

In an example embodiment, the NIC 3240 may include a network interface card and a network adaptor. The NIC 3240 may be connected to the network 3300 by a wired interface, a wireless interface, a Bluetooth interface, or an optical interface. The NIC 3240 may include an internal memory, a digital signal processor (DSP), and a host bus interface and be connected to the processor 3210 and/or the switch 3230 through the host bus interface. The host bus interface may be implemented as one of the above-described examples of the interface 3254. In an example embodiment, the NIC 3240 may be integrated with at least one of the processor 3210, the switch 3230, and the storage device 3250.

In the storage servers 3200 to 3200m or the application servers 3100 to 3100n, a processor may transmit a command to storage devices 3150 to 3150n and 3250 to 3250m or the memories 3120 to 3120n and 3220 to 3220m and program or read data. In this case, the data may be data of which an error is corrected by an ECC engine. The data may be data on which a data bus inversion (DBI) operation or a data masking (DM) operation is performed, and may include cyclic redundancy code (CRC) information. The data may be data encrypted for security or privacy.

Storage devices 3150 to 3150n and 3250 to 3250m may transmit a control signal and a command/address signal to NAND flash memory devices 3252 to 3252m in response to a read command received from the processor. Thus, when data is read from the NAND flash memory devices 3252 to 3252m, a read enable (RE) signal may be input as a data output control signal, and thus, the data may be output to a DQ bus. A data strobe signal DQS may be generated using the RE signal. The command and the address signal may be latched in a page buffer depending on a rising edge or falling edge of a write enable (WE) signal.

The controller 3251 may control all operations of the storage device 3250. In an example embodiment, the controller 3251 may include SRAM. The controller 3251 may write data to the NAND flash memory device 3252 in response to a write command or read data from the NAND flash memory device 3252 in response to a read command. For example, the write command and/or the read command may be provided from the processor 3210 of the storage server 3200, the processor 3210m of another storage server 3200m, or the processors 3110 and 3110n of the application servers 3100 and 3100n. DRAM 3253 may temporarily store (or buffer) data to be written to the NAND flash memory device 3252 or data read from the NAND flash memory device 3252. Also, the DRAM 3253 may store metadata. Here, the metadata may be user data or data generated by the controller 3251 to manage the NAND flash memory device 3252. The storage device 3250 may include a secure element (SE) for security or privacy.

According to an example embodiment of the present disclosure, a data center system (for example, data center 3000) is provided, the system includes a plurality of application servers (for example, application servers 3100-3100n) and a plurality of storage servers (for example, storage servers 3200-3200m), wherein each of the plurality of application servers is configured to perform the method for configuring zones of the ZNS SSD performed by for example the host as described herein and/or each of the plurality of storage servers is configured to perform the method for configuring zones of the ZNS SSD performed by the ZNS SSD as described herein.

According to an example embodiment of the present disclosure, there may be provided a computer-readable storage medium storing instructions, when executed by at least one processor, causing the at least one processor to perform the method for configuring zones of a ZNS SSD according to the present disclosure. Examples of computer-readable storage media here include: read only memory (ROM), random access programmable read only memory (PROM), electrically erasable programmable read only memory (EEPROM), random access memory (RAM), dynamic random access memory (DRAM), static random access memory (SRAM), flash memory, non-volatile memory, CD-ROM, CD-R, CD+R, CD-RW, CD+RW, DVD-ROM, DVD-R, DVD+R, DVD-RW, DVD+RW, DVD-RAM, BD-ROM, BD-R, BD-R LTH, BD-RE, Blu-ray or optical disc storage, hard disk drive (HDD), solid state Hard disk (SSD), card storage (such as multimedia card, secure digital (SD) card or extreme digital (XD) card), magnetic tape, floppy disk, magneto-optical data storage device, optical data storage device, hard disk, solid state disk and any other devices configured to store computer programs and any associated data, data files, and data structures in a non-transitory manner, and provide the computer programs and any associated data, data files, and data structures to the processor or the computer, so that the processor or the computer can execute the computer program. The computer program in the above-mentioned computer-readable storage medium may run in an environment deployed in computing equipment such as a client, a host, an agent device, a server, etc. In addition, in one example, the computer program and any associated data, data files and data structures are distributed on networked computer systems, so that computer programs and any associated data, data files, and data structures are stored, accessed, and executed in a distributed manner through one or more processors or computers.

According to an example embodiment of the present disclosure, there may be provided a computer program product, wherein instructions in the computer program product may be executed by a processor of a computer device to implement the method for configuring zones of ZNS SSD described herein.

Those skilled in the art will easily think of other example embodiments of the present disclosure after considering the specification and practicing the disclosure disclosed herein. The present disclosure is intended to cover any variations, uses, or adaptive changes of the present disclosure. These variations, uses, or adaptive changes follow the general principles of the present disclosure and include common knowledge or conventional technical means in the technical field that are not disclosed in the present disclosure. The specification and the example embodiments are to be regarded as examples only, and the actual scope and spirit of the present disclosure are pointed out by the following claims.

Any functional blocks shown in the figures and described above may be implemented in processing circuitry such as hardware including logic circuits, a hardware/software combination such as a processor executing software, or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

1. A method for configuring zones of a Zoned Namespace (ZNS) Solid State Drive (SSD), comprising:
determining types of sizes of zones into which storage space of the ZNS SSD is to be divided and a number of zones having each type of size; and
sending information indicating the types of sizes of the zones and the number of zones having each type of size to the ZNS SSD such that the storage space of the ZNS SSD is divided into zones having different sizes.

2. The method of claim 1, wherein the determining of the types of the sizes of the zones into which the storage space of the ZNS SSD is to be divided and the number of the zones having each type of size comprises:
determining a first number of zones having a first size and a second number of zones having a second size,
wherein the sending information indicating the types of sizes of the zones and a number of zones having each type of size to the ZNS SSD to cause the storage space of the ZNS SSD to be divided into the zones having different sizes comprises:
sending the first size, the first number, the second size, and the second number to the ZNS SSD such that the storage space of the ZNS SSD to be divided into the first number of zones having the first size and the second number of zones having the second size.

3. The method of claim 2, wherein each zone having the first size spans a third number of NAND dies of the ZNS SSD, and each zone having the second size spans a fourth number of NAND dies of the ZNS SSD, and
wherein the third number is less than the fourth number and the first size is less than the second size.

4. The method of claim 3, the third number is 1.

5. The method of claim 2, wherein the method further comprises:
receiving a user input comprising the first size, the first number, and the second size; or the first size, the second size, and the second number, and
wherein the determining of the first number of zones having the first size and the second number of zones having the second size comprises:
determining the first number of zones having the first size and the second number of zones having the second size based on the user input.

6. The method of claim 5, wherein the user input corresponds to one of feature identifiers 19h to 77h in an NVMe specification.

7. (canceled)

8. A device for configuring zones of Zoned Namespace (ZNS) Solid State Drive (SSD), comprising:
a determining unit configured to determine types of sizes of zones into which storage space of the ZNS SSD is to be divided and a number of zones having each type of size; and
a sending unit configured to send information indicating the types of the sizes of the zones and the number of zones having each type of size to the ZNS SSD such that the storage space of the ZNS SSD to be divided into zones having different sizes.

9. The device of claim 8, wherein the determining unit is configured to determine a first number of zones having a first size and a second number of zones having a second size,
wherein the sending unit is configured to send the first size, the first number, the second size, and the second number to the ZNS SSD to cause the storage space of the ZNS SSD to be divided into the first number of zones having the first size and the second number of zones having the second size.

10. The device of claim 9, wherein each zone having the first size spans a third number of NAND dies of the ZNS SSD, and each zone having the second size spans a fourth number of NAND dies of the ZNS SSD, and wherein the third number is less than the fourth number and the first size is less than the second size.

11. The device of claim 10, the third number is 1.

12. The device of claim 9, wherein the device further comprises:
a receiving unit configured to receive a user input comprising the first size, the first number, and the second size; or the first size, the second size, and the second number,
wherein the determining unit is configured to determine the first number of zones having the first size and the second number of zones having the second size based on the user input.

13. The device of claim 12, wherein the user input corresponds to one of the feature identifiers 19h to 77h in an NVMe specification.

14. A Zoned Namespace (ZNS) Solid State Drive (SSD), comprising:
a receiving unit configured to receive information indicating types of sizes of zones into which storage space of the ZNS SSD is to be divided and a number of zones having each type of size from a host; and
a dividing unit configured to divide the storage space of the ZNS SSD into zones having different sizes based on the information.

15.-18. (canceled)
